(19) United States
(12) Patent Application Publication
(10) Pub. No.: US 2025/0310052 A1
(43) Pub. Date: Oct. 2, 2025

(54) UPLINK DATA OR UPLINK CONTROL INFORMATION WITH UPLINK RESOURCE MUTING PATTERN

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US); Qian ZHANG, Basking Ridge, NJ (US)

(21) Appl. No.: 19/039,124

(22) Filed: Jan. 28, 2025

Related U.S. Application Data
(60) Provisional application No. 63/571,863, filed on Mar. 29, 2024.

(51) Int. Cl. H04L 5/00; H04B 7/06; H04L 1/1812; H04W 72/21

(52) U.S. Cl. CPC H04L 5/0048; H04B 7/0626; H04L 1/1812; H04W 72/21

(57) ABSTRACT

Various aspects of the present disclosure generally relate to wireless communication. Some aspects more specifically relate to uplink resource muting patterns that overlap with one or more physical uplink shared channel (PUSCH) symbols in a sub-band full duplex (SBFD) slot. In some aspects, a user equipment (UE) may transmit, and a network node may receive, in accordance with the uplink resource muting pattern, uplink data or uplink control information (UCI) in one or more available resources associated with the one or more PUSCH symbols.

### CROSS-REFERENCE TO RELATED APPLICATION

This patent application claims priority to U.S. Provisional Patent Application No. 63/571,863, filed on Mar. 29, 2024, entitled “UPLINK DATA OR UPLINK CONTROL INFORMATION WITH UPLINK RESOURCE MUTING PATTERN,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with uplink data or uplink control information with an uplink resource muting pattern.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples.

Non-transparent uplink resource muting may impact techniques associated with uplink data or uplink control information (UCI). As one example, virtual resource blocks assigned for transmission may not account for resources that are reserved for uplink resource muting. As another example, uplink resource muting resources may be excluded from available resources for UCI or included in a reserved set if certain UCI (for example, channel state information (CSI) part 2 information) and/or uplink data are punctured. Without accounting for such impacts, non-transparent uplink resource muting may not support uplink data or UCI.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive an indication of an uplink resource muting pattern, wherein the uplink resource muting pattern overlaps with one or more physical uplink shared channel (PUSCH) symbols in a sub-band full duplex (SBFD) slot. At least one processor of the one or more processors may be configured to cause the UE to transmit, in accordance with the uplink resource muting pattern, uplink data or uplink control information (UCI) in one or more available resources associated with the one or more PUSCH symbols.

Some aspects described herein relate to an apparatus for wireless communication at a network node. The apparatus may include one or more memories storing processor-executable code and one or more processors coupled with the one or more memories. At least one processor of the one or more processors may be configured to cause the network node to transmit an indication of an uplink resource muting pattern, wherein the uplink resource muting pattern overlaps with one or more PUSCH symbols in an SBFD slot. At least one processor of the one or more processors may be configured to cause the network node to receive, in accordance with the uplink resource muting pattern, uplink data or UCI in one or more available resources associated with the one or more PUSCH symbols.

Some aspects described herein relate to a method of wireless communication performed at a UE. The method may include receiving an indication of an uplink resource muting pattern, wherein the uplink resource muting pattern overlaps with one or more PUSCH symbols in an SBFD slot. The method may include transmitting, in accordance with the uplink resource muting pattern, uplink data or UCI in one or more available resources associated with the one or more PUSCH symbols.

Some aspects described herein relate to a method of wireless communication performed at a network node. The method may include transmitting an indication of an uplink resource muting pattern, wherein the uplink resource muting pattern overlaps with one or more PUSCH symbols in an SBFD slot. The method may include receiving, in accordance with the uplink resource muting pattern, uplink data or UCI in one or more available resources associated with the one or more PUSCH symbols.

Some aspects described herein relate to a non-transitory computer-readable medium storing a set of instructions for wireless communication. The set of instructions includes one or more instructions that, when executed at a UE, may cause the UE to receive an indication of an uplink resource muting pattern, wherein the uplink resource muting pattern overlaps with one or more PUSCH symbols in an SBFD slot. The set of instructions includes one or more instructions that, when executed at the UE, may cause the UE to transmit, in accordance with the uplink resource muting pattern, uplink data or UCI in one or more available resources associated with the one or more PUSCH symbols.

Some aspects described herein relate to a non-transitory computer-readable medium storing a set of instructions for wireless communication. The set of instructions includes one or more instructions that, when executed at a network node, may cause the network node to transmit an indication of an uplink resource muting pattern, wherein the uplink resource muting pattern overlaps with one or more PUSCH symbols in an SBFD slot. The set of instructions includes one or more instructions that, when executed at the network node, may cause the network node to receive, in accordance with the uplink resource muting pattern, uplink data or UCI in one or more available resources associated with the one or more PUSCH symbols.

Some aspects described herein relate to an apparatus for wireless communication. The apparatus may include means for receiving an indication of an uplink resource muting pattern, wherein the uplink resource muting pattern overlaps with one or more PUSCH symbols in an SBFD slot. The apparatus may include means for transmitting, in accordance with the uplink resource muting pattern, uplink data or UCI in one or more available resources associated with the one or more PUSCH symbols.

Some aspects described herein relate to an apparatus for wireless communication. The apparatus may include means for transmitting an indication of an uplink resource muting pattern, wherein the uplink resource muting pattern overlaps with one or more PUSCH symbols in an SBFD slot. The apparatus may include means for receiving, in accordance with the uplink resource muting pattern, uplink data or UCI in one or more available resources associated with the one or more PUSCH symbols.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description May enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example network node in communication with an example user equipment (UE) in a wireless network.

FIG. 3 is a diagram illustrating examples of full-duplex communication in a wireless network.

FIG. 4 is a diagram illustrating examples of full-duplex communications.

FIGS. 5A-5D are diagrams illustrating examples associated with uplink control information (UCI) mapping.

FIG. 6 is a diagram illustrating an example associated with non-transparent uplink resource muting.

FIG. 7 is a flowchart illustrating an example process performed, for example, at a UE or an apparatus of a UE that supports uplink data or UCI with an uplink resource muting pattern.

FIG. 8 is a flowchart illustrating an example process performed, for example, at a network node or an apparatus of a network node that supports uplink data or UCI with an uplink resource muting pattern.

FIG. 9 is a diagram of an example apparatus for wireless communication, such as a UE, that supports uplink data or UCI with an uplink resource muting pattern.

FIG. 10 is a diagram of an example apparatus for wireless communication, such as a network node, that supports uplink data or UCI with an uplink resource muting pattern.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

“Full-duplex communication” in a wireless network refers to simultaneous bi-directional communication between devices in the wireless network. In sub-band full duplex (SBFD), a network node may receive an uplink communication from a UE and transmit a downlink communication to a UE at the same time, but on different frequency resources. In some scenarios, SBFD operation may lead to inter-network-node cross-link interference (CLI). Inter-network-node CLI may occur when reception of a communication (for example, from a UE) at a network node overlaps in time with transmission of a communication from a neighboring network node. For example, the communication transmitted from the neighboring network node may interfere with the communication received from the UE.

In some examples, uplink resource muting may be used to support an inter-network-node CLI measurement and thereby suppress inter-network-node CLI. Uplink resource muting may involve muting of one or more uplink resources (for example, one or more UEs may refrain from transmitting uplink communications on the uplink resource(s)). In some examples, uplink resource muting may be based at least in part on non-transparent uplink resource muting, which may involve defining an uplink resource muting pattern. An uplink resource muting pattern (or uplink resource pattern) may define which uplink resources are designated for muting.

Non-transparent uplink resource muting may impact techniques associated with uplink data or uplink control information (UCI). As one example, virtual resource blocks (VRBs) assigned for transmission may not account for resources that are reserved for uplink resource muting. As another example, uplink resource muting resources may be excluded from available resources for UCI or included in a reserved set if certain UCI (for example, channel state information (CSI) part 2 information) and/or uplink data are punctured. Without accounting for such impacts, non-transparent uplink resource muting may not support uplink data or UCI.

Various aspects relate generally to uplink resource muting. Some aspects more specifically relate to uplink resource muting patterns that overlap with one or more physical uplink shared channel (PUSCH) symbols in an SBFD slot. In some aspects, a user equipment (UE) may transmit, and a network node may receive, in accordance with the uplink resource muting pattern, uplink data or UCI in one or more available resources associated with the one or more PUSCH symbols.

In some aspects, the UE may rate-match the uplink data and the UCI in accordance with the uplink resource muting pattern. Rate-matching may involve avoiding resources reserved for muting during resource mapping.

In some aspects, the UE may puncture the uplink data and rate-match the UCI in accordance with the uplink resource muting pattern. For example, the UE may use the uplink resource muting pattern to rate-match UCI and puncture at least some information carried by the PUSCH.

In some aspects, the UE may rate-match hybrid automatic repeat request acknowledgment (HARQ-ACK) information, CSI part 1 information, and CSI part 2 information. For example, the UE may use rate-matching for all UCI types and no uplink data.

In some aspects, the UE may rate-match HARQ-ACK information and CSI part 1 information and puncture CSI part 2 information. For example, the HARQ-ACK information and CSI part 1 information may be mapped around muted resources.

In some aspects, the UE may rate-match HARQ-ACK information and puncture CSI part 1 information and CSI part 2 information. For example, the HARQ-ACK information may be mapped around muted resources.

Particular aspects of the subject matter described in this disclosure can be implemented to realize one or more of the following potential advantages. In some examples, by transmitting or receiving, in accordance with the uplink resource muting pattern, the uplink data or UCI in one or more available resources associated with the one or more PUSCH symbols, the described techniques can be used to enable uplink resource muting (for example, non-transparent uplink resource muting) to support uplink data or UCI. As a result, uplink resource muting may assist in performing accurate inter-node CLI measurements to suppress interference in cases where the UE is to transmit a PUSCH communication.

Rate-matching the uplink data and the UCI in accordance with the uplink resource muting pattern may help to ensure that the uplink data and the UCI are transmitted with high reliability.

Puncturing the uplink data and rate-matching the UCI in accordance with the uplink resource muting pattern may reduce complexity at the UE by avoiding rate-matching of uplink data and maintain high reliability for at least certain UCI types.

Rate-matching HARQ-ACK information, CSI part 1 information, and CSI part 2 information may reduce complexity at the UE by avoiding rate-matching of uplink data and maintain high reliability for HARQ-ACK information, CSI part 1 information, and CSI part 2 information.

Rate-matching HARQ-ACK information and CSI part 1 information and puncturing CSI part 2 information may further reduce complexity at the UE by avoiding rate-matching of uplink data and CSI part 2 information and maintain high reliability for HARQ-ACK information and CSI part 1 information.

Rate-matching HARQ-ACK information and puncturing CSI part 1 information and CSI part 2 information may further reduce complexity at the UE by avoiding rate-matching of uplink data, CSI part 1 information, and CSI part 2 information and maintain high reliability for HARQ-ACK information.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

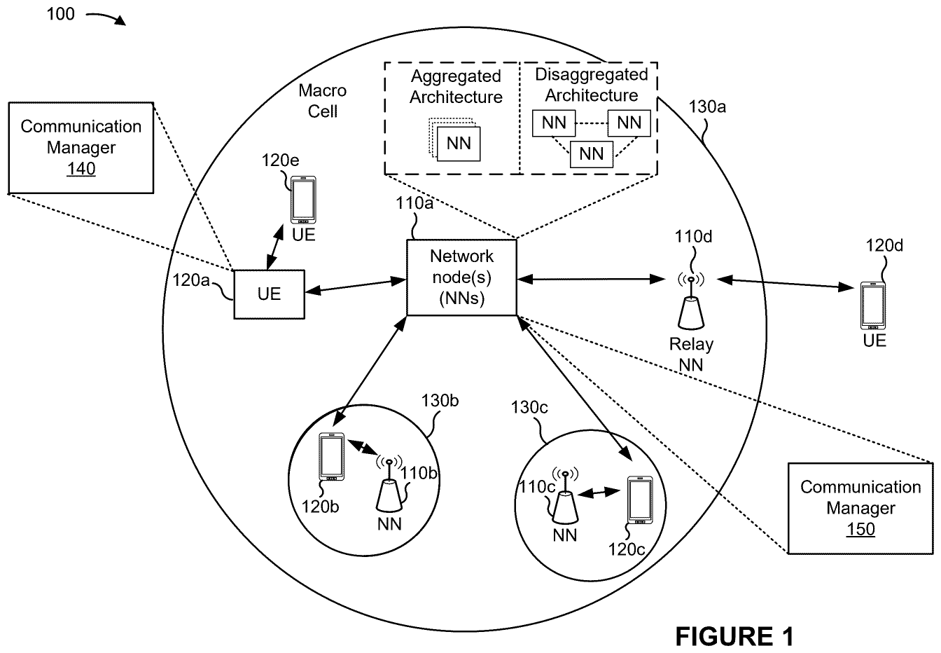

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long-Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication.

In some aspects, the UE 120 may include a communication manager 140. As described in more detail elsewhere herein, the communication manager 140 may receive an indication of an uplink resource muting pattern, wherein the uplink resource muting pattern overlaps with one or more PUSCH symbols in an SBFD slot; and transmit, in accordance with the uplink resource muting pattern, uplink data or UCI in one or more available resources associated with the one or more PUSCH symbols. Additionally or alternatively, the communication manager 140 may perform one or more other operations described herein.

In some aspects, the network node 110 may include a communication manager 150. As described in more detail elsewhere herein, the communication manager 150 may transmit an indication of an uplink resource muting pattern, wherein the uplink resource muting pattern overlaps with one or more PUSCH symbols in an SBFD slot; and receive, in accordance with the uplink resource muting pattern, uplink data or UCI in one or more available resources associated with the one or more PUSCH symbols. Additionally or alternatively, the communication manager 150 may perform one or more other operations described herein.

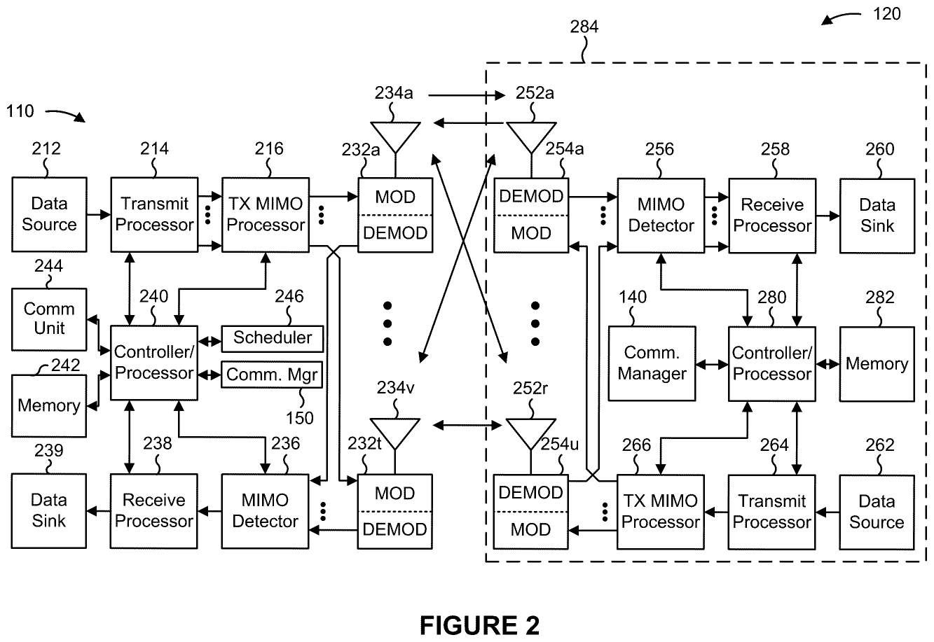

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor” or “a/the controller/processor,” among other examples (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use downlink control information (DCI) to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may identify, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC control element (MAC-CE) communication, an RRC communication, or another type of uplink communication. Uplink signals may be transmitted on a PUSCH, a physical uplink control channel (PUCCH), and/or another type of uplink channel. An uplink signal may carry one or more transport blocks (TBs) of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

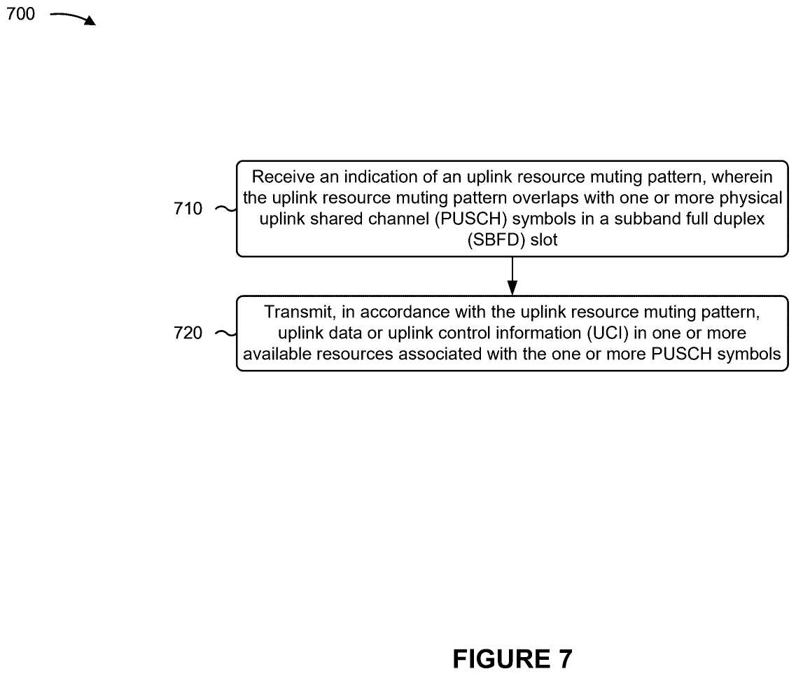

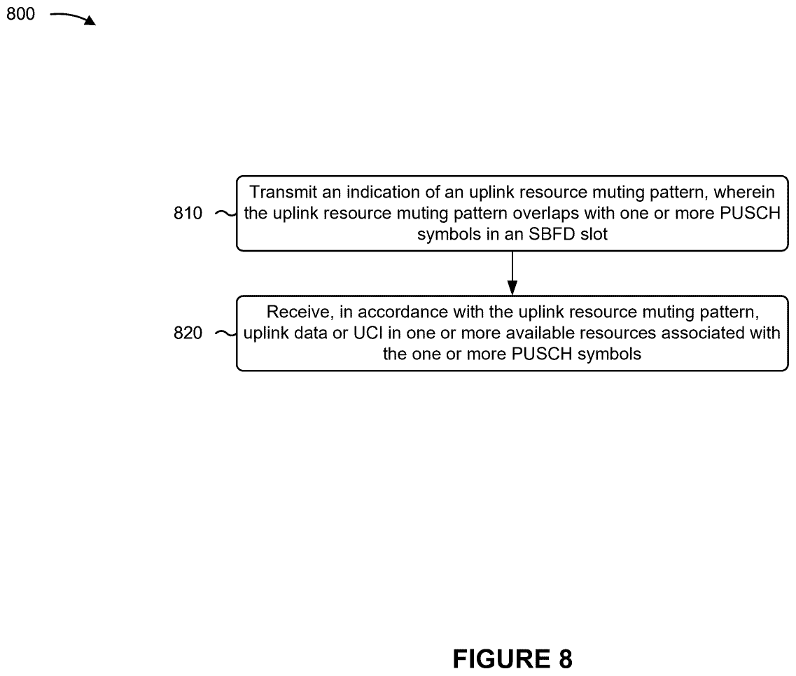

The network node 110, the controller/processor 240 of the network node 110, the UE 120, the controller/processor 280 of the UE 120, a CU, a DU, an RU, or any other component(s) of FIG. 1 or 2 may implement one or more techniques or perform one or more operations associated with uplink data or UCI with an uplink resource muting pattern, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 700 of FIG. 7, process 800 of FIG. 8, or other processes as described herein (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, the UE 120 includes means for receiving an indication of an uplink resource muting pattern, wherein the uplink resource muting pattern overlaps with one or more PUSCH symbols in an SBFD slot; and/or means for transmitting, in accordance with the uplink resource muting pattern, uplink data or UCI in one or more available resources associated with the one or more PUSCH symbols. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication of an uplink resource muting pattern, wherein the uplink resource muting pattern overlaps with one or more PUSCH symbols in an SBFD slot; and/or means for receiving, in accordance with the uplink resource muting pattern, uplink data or UCI in one or more available resources associated with the one or more PUSCH symbols. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

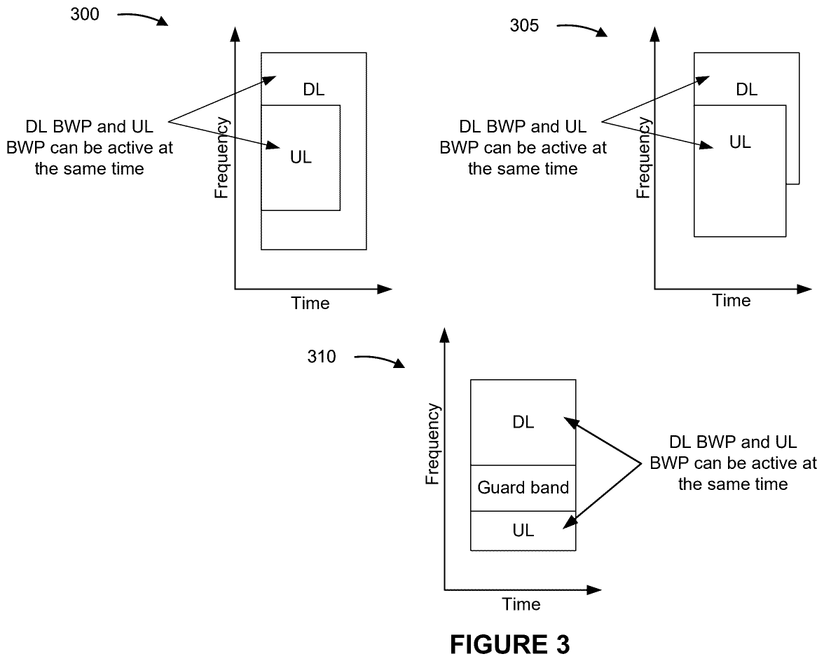

FIG. 3 is a diagram illustrating examples 300, 305, and 310 of full-duplex communication in a wireless network. “Full-duplex communication” in a wireless network refers to simultaneous bi-directional communication between devices in the wireless network. For example, a network node may receive an uplink communication from a UE and transmit a downlink communication to a UE at the same time (for example, in the same slot or the same symbol). “Half-duplex communication” in a wireless network refers to unidirectional communications (for example, only downlink communication or only uplink communication) between devices at a given time (for example, in a given slot or a given symbol). There are two flavors of full-duplex operation: in-band full-duplex (IBFD) and SBFD.

As shown in FIG. 3, examples 300 and 305 show examples of IBFD communication. In IBFD, a UE may transmit an uplink communication to a network node and receive a downlink communication from the network node on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

As further shown in FIG. 3, example 310 shows an example of SBFD communication, which may also be referred to as “sub-band frequency division duplex” (SBFDD) or “flexible duplex.” In SBFD, a UE may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

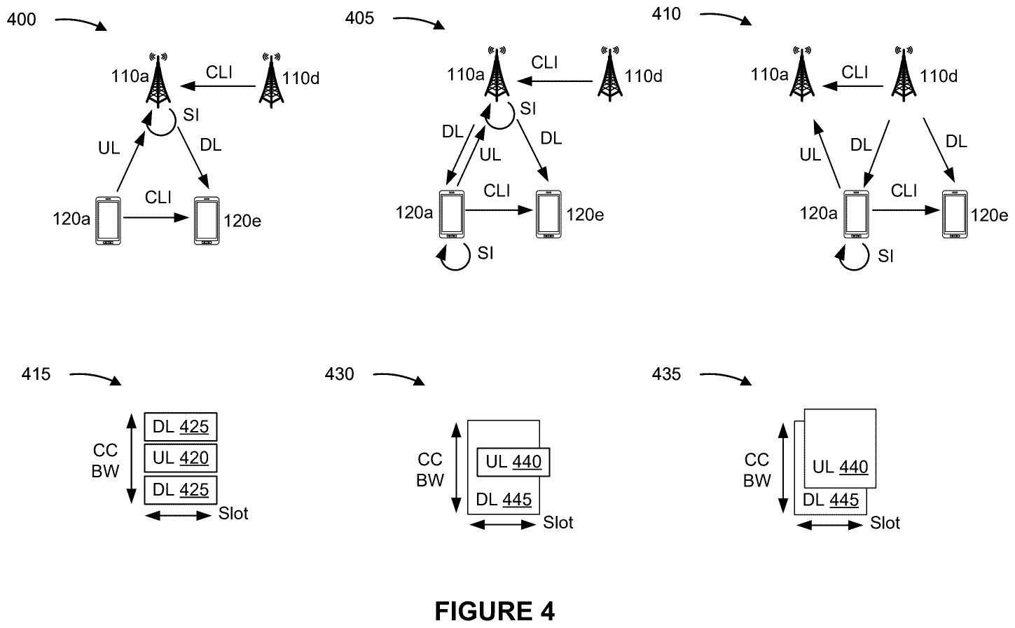

FIG. 4 is a diagram illustrating examples 400, 405, and 410 of full-duplex communications. In examples 400, 405, and 410, network node 110a and/or network node 110d may communicate with UEs 120a and/or UEs 120c.

In example 400, the network nodes 110a and 110d may be full-duplex network nodes, and UEs 120a and 120e may be half-duplex UEs. As shown, network node 110a may receive an uplink transmission (“UL”) from the UE 120a and transmit a downlink transmission (“DL”) to the UE 120c. The network node 110a may simultaneously receive the uplink transmission and transmit the downlink transmission on the same slot. In some examples, the network node 110a may experience self-interference (“SI”) as a result of the downlink transmission leaking into a port that receives the uplink transmission. Additionally or alternatively, the UE 120e may be subjected to cross-link interference (CLI) from the UE 120a (for example, inter-UE CLI). Additionally or alternatively, the network node 110a may be subjected to CLI from the network node 110d (for example, inter-network-node CLI).

In example 405, the network nodes 110a and 110d may be full-duplex network nodes, and UEs 120a and 120e may be full-duplex UEs. As shown, network node 110a may receive an uplink transmission from the UE 120a and transmit downlink transmissions to respective UEs 120a and 120e. The network node 110a may simultaneously receive the uplink transmission and transmit the downlink transmissions on the same slot. In some examples, the network node 110a may experience self-interference as a result of the downlink transmission(s) leaking into a port that receives the uplink transmission. Additionally or alternatively, the UE 120e may be subjected to CLI (for example, inter-UE CLI) from the UE 120a. Additionally or alternatively, the network node 110a may be subjected to CLI (for example, inter-network-node CLI) from the network node 110d. Additionally or alternatively, the UE 120a may experience self-interference as a result of the uplink transmission leaking into a port that receives the downlink transmission to the UE 120a.

In example 410, the network nodes 110a and 110d may be full-duplex network nodes, and UEs 120a and 120c may be SBFD UEs. Example 410 may involve a multiple transmission reception point (M-TRP) scenario in which both network nodes 110a and 110d serve UEs 120a and 120e simultaneously. As shown, the network node 110a may receive an uplink transmission from the UE 120a, and the network node 110c may transmit downlink transmissions to respective UEs 120a and 120e. The network node 110a may receive the uplink transmission on the same slot that the network node 110d transmits the downlink transmissions (for example, the uplink and downlink transmissions may be simultaneous). Unlike in example 405, the network node 110a may avoid self-interference because the network node 110d, rather than network node 110a, transmits the downlink transmissions to the UEs 120a and 120c. Additionally or alternatively, the UE 120e may be subjected to CLI from the UE 120a (for example, inter-UE CLI). Additionally or alternatively, the network node 110a may be subjected to CLI from the network node 110d (for example, inter-network-node CLI). Additionally or alternatively, the UE 120a may experience self-interference as a result of the uplink transmission leaking into a port that receives the downlink transmission to the UE 120a.

In examples 400, 405, and/or 410, the UE 120a and/or the UE 120e may be configured with a full-duplex configuration, such as an SBFD configuration or an IBFD configuration. In some examples, the UE 120a and/or the UE 120e may be configured with an SBFD configuration 415 that contains uplink sub-band 420 and downlink sub-bands 425. The uplink sub-band 420 and the downlink sub-bands 425 may be arranged, in the same slot, within a component carrier (CC) bandwidth in a non-overlapping manner in the frequency domain. For example, the UE 120a may transmit the uplink transmission on the uplink sub-band 420, and the UE 120e may receive the downlink transmission on one or more of the downlink sub-bands 425.

In some examples, the UE 120a and/or the UE 120e may be configured with an IBFD configuration that contains partially-overlapping or fully-overlapping uplink resources and downlink resources. IBFD configurations 430 and 435 show example arrangements of partially-overlapping uplink resources 440 and downlink resources 445. In IBFD configuration 430, the highest frequency of the uplink resources 440 is less than the highest frequency of the downlink resources 445, and in IBFD configuration 435, the highest frequency of the uplink resources 440 is greater than the highest frequency of the downlink resources 445 In some examples, the UE 120a may be configured with an SBFD slot that contains the uplink resources 440 and the downlink resources 445. For example, the UE 120a may transmit the uplink transmission on the uplink resources 440, and the UE 120a and/or the UE 120e may receive the downlink transmissions on the downlink resources 445.

An SBFD operation may increase an uplink duty cycle, which may result in a latency reduction (for example, a downlink signal may be received in uplink-only slots, which may enable latency savings) and uplink coverage improvement. Additionally or alternatively, the SBFD operation may improve a system capacity, resource utilization, and/or spectrum efficiency. Additionally or alternatively, the SBFD operation may enable a flexible and dynamic uplink/downlink resource adaptation according to uplink/downlink traffic in a robust manner.

As shown by examples 400-420, full duplex operation may lead to inter-network-node CLI. In some examples, uplink resource muting may be used to support an inter-network-node CLI measurement. For example, uplink resource muting may be used to measure spatial characteristics of network-node-to-network-node CLI caused by various downlink signals and thereby avoid CLI.

For a network-node-to-network-node co-channel CLI measurement and/or channel measurement (for example, gNB-to-gNB co-channel CLI measurement and/or channel measurement), an uplink resource muting may be based at least in part on transparent uplink resource muting or non-transparent uplink resource muting. Transparent uplink resource muting may involve avoiding scheduling transmissions on a measurement resource. Non-transparent uplink resource muting may involve defining an uplink resource muting pattern with one or more resource element (RE) or resource block (RB) muting patterns.

The uplink resource muting for the network-node-to-network-node co-channel CLI measurement and/or channel measurement may be used to measure a network-node-to-network-node (for example, gNB-to-gNB) CLI level with less interference from an uplink resource. The uplink resource muting may be used to measure a network-node-to-network-node channel with less interference from an uplink resource. The uplink resource muting may be used to measure a network-node-to-network-node CLI interference covariance matrix with less interference from an uplink resource. Transparent uplink resource muting may be supported using network node scheduling. The uplink resource muting may incur an uplink performance loss. A UE complexity and a potential increased peak-to-average power ratio (PAPR) impact of non-contiguous uplink transmissions may be considered when introducing non-transparent uplink resource muting.

Non-transparent uplink resource muting may enable a network-node-to-network-node co-channel CLI handling scheme by enabling network-node-to-network-node co-channel CLI and/or channel measurement. In some examples, non-transparent uplink resource muting may involve non-transparent uplink resource muting patterns at the RE-level or RB-level muting patterns, such as a comb-2 RE-level or RB-level muting pattern for PUSCH. A non-transparent uplink resource muting pattern may impact power control on symbols with RE-level uplink resource muting and/or uplink UCI bit mapping. Furthermore, non-transparent uplink resource muting may involve an indication of the non-transparent uplink resource muting pattern, impact PUSCH rate-matching and power allocation, or collision-handling with DMRS and/or phase tracking reference signal (PTRS), among other examples. In some examples, rate-matching may refer to techniques for mapping signals to resources (for example, time and/or frequency resources) around (for example, by avoiding) select resources.

Additionally or alternatively, the network-node-to-network-node co-channel CLI handling scheme may involve an information exchange associated with a channel measurement; reference signals for the channel measurement; an information exchange associated with a measurement resource configuration (for example, a non-zero-power (NZP) channel state information reference signal (CSI-RS) or a non-cell-defining synchronization signal block (NCD-SSB), among other examples); an information exchange associated with a downlink beam indication; or an information exchange of preferred or restricted downlink beam information and associated resource configuration; among other examples.

Non-transparent uplink resource muting based interference rejection combining (IRC) with one symbol of uplink overhead and one symbol of downlink overhead may have: a similar mean downlink average user perceived throughput (UPT) for low load levels and medium load levels; a lower mean downlink average UPT for high load levels; a higher or similar 5% downlink average UPT for all load levels; and/or a higher mean uplink average UPT and a similar 5% uplink average UPT for all load levels.

A network-node-to-network-node co-channel CLI handling scheme (for example, a scheme where network-node-to-network-node co-channel CLI and/or channel measurement is used as an enabler for spatial-domain-based schemes) may help to suppress leakage interference, may increase PAPR for DFT-s-OFDM for certain uplink resource muting patterns, and may increase UE implementation complexity (for example, rate matching or power allocation, among other examples).

Non-transparent uplink resource muting may impact at least mapping to VRBs for PUSCH, UCI resource calculation, UCI mapping rules on PUSCH, or a definition of uplink resource muting and activation method, among other examples. With respect to mapping of VRBs on PUSCH, for each of the antenna ports used for transmission of the PUSCH, the block of complex-valued symbols z^{(p)}(0), . . . , z^{(p)}(M_{symb}^{ap}−1) may be multiplied with the amplitude scaling factor β_{PUSCH} in order to conform to a specified transmit power and mapped in sequence starting with z^{(p)}(0) to REs (k′, l)_{p,μ} in the VRBs assigned for transmission that meet all of the following criteria: the VRBs are in the virtual resource blocks assigned for transmission; and the corresponding REs in the corresponding physical RBs are not used for transmission of the associated DMRS, PTRS, or DMRS intended for other co-scheduled UEs. The mapping to REs (k′, l)_{p,μ} allocated for PUSCH may be in increasing order of, first, the index k′ over the assigned VRBs, where k′=0 is the first subcarrier in the lowest-numbered VRB assigned for transmission, and then the index l, with a given starting position. This may impact the REs in the set Φₗ^{UL-SCH}, which may be used for resource mapping. Φₗ^{UL-SCH} may denote the set of REs, in ascending order of indices k, available for transmission of data in OFDM symbol l, for l=0, 1, 2, . . . , N_{symb,all}^{PUSCH}−1. The VRBs assigned for transmission may not account for REs reserved for uplink resource muting.

UCI resource calculation may involve identifying which resources are associated with different UCI types. For HARQ-ACK transmission on PUSCH not using repetition type B with uplink shared channel (UL-SCH) and if numberOfSlotsTBoMS is not present in the resource allocation table, or if numberOfSlotsTBoMS is present in the resource allocation table and the value of numberOfSlotsTBoMS in the row indicated by the time domain resource assignment field in DCI is equal to 1, the number of coded modulation symbols per layer for HARQ-ACK transmission, denoted as Q′_{ACK}, may be calculated as follows:

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \} ,$$

where O_{ACK} is the number of HARQ-ACK bits; M_{sc}^{PUSCH} is the scheduled bandwidth of the PUSCH transmission, expressed as a number of subcarriers; M_{sc}^{UCI}(l) is the number of resource elements that can be used for transmission of UCI in OFDM symbol l, for l=0, 1, 2, . . . , N_{symb,all}^{PUSCH}−1, in the PUSCH transmission, and N_{symb,all}^{PUSCH} is the total number of OFDM symbols of the PUSCH, including all OFDM symbols used for DMRS. In some examples, for any OFDM symbol that carries DMRS of the PUSCH, M_{sc}^{UCI}(l)=0. In some examples, for any OFDM symbol that does not carry DMRS of the PUSCH, M_{sc}^{UCI}(l)=M_{sc}^{PUSCH}−M_{sc}^{PT-RS}(l).

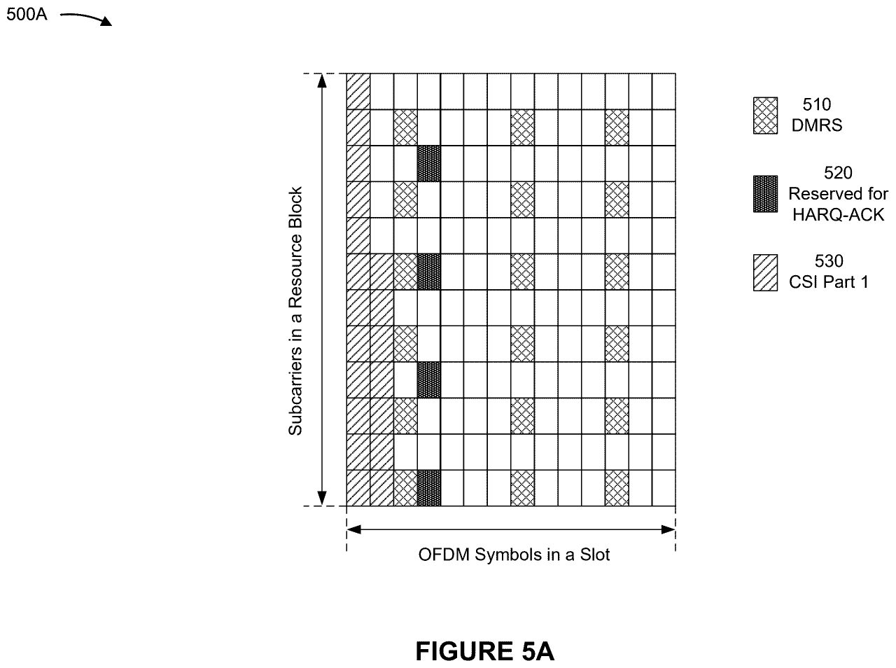

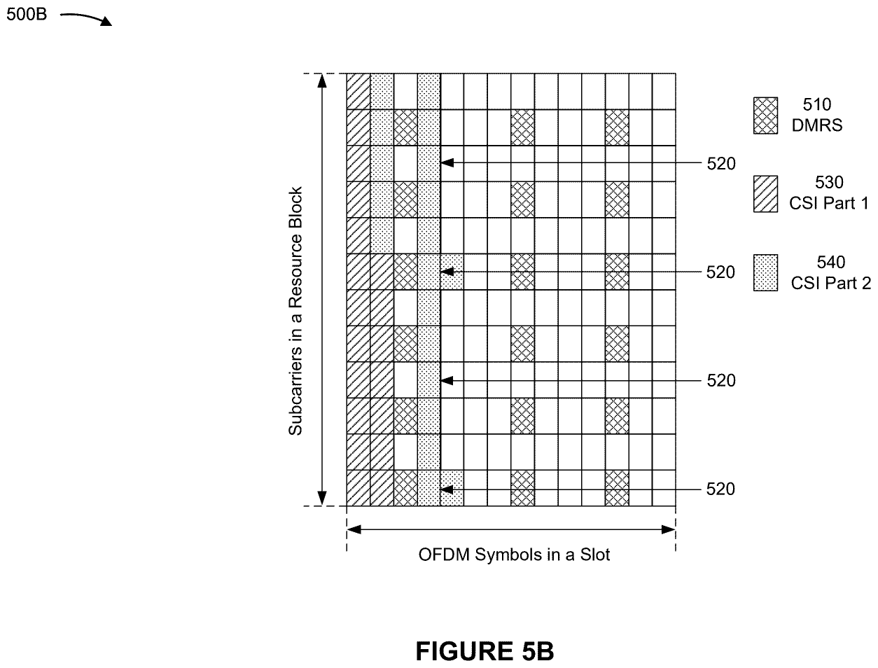

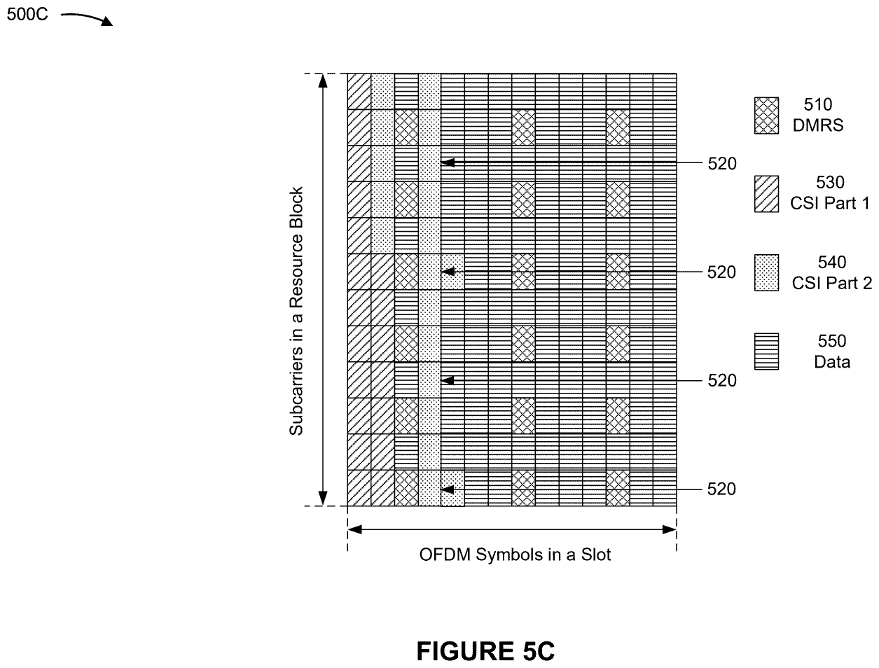

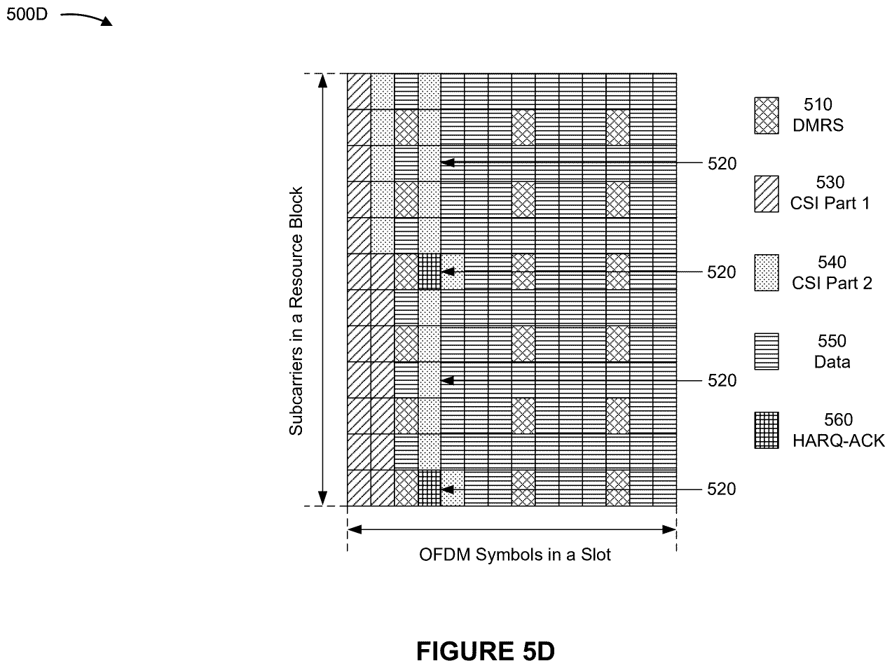

FIGS. 5A-5D are diagrams illustrating examples 500A-500D associated with UCI mapping.

The UE 120 may puncture or rate-match the PUSCH with HARQ-ACK in accordance with one or more RE mapping rules for UCI on PUSCH. In some examples, the UE 120 may map the HARQ-ACK to REs around DMRS symbol(s). In some examples, the UE 120 may map modulated HARQ-ACK symbols starting on the first available non-DMRS symbol after the first DMRS symbol(s), regardless of the quantity of DMRS symbols in a PUSCH (for example, UCI) transmission. In some examples, the UE 120 may map CSI part 1 and CSI part 2 starting on the first available non-DMRS symbol, regardless of the quantity of DMRS symbols in the PUSCH transmission.

Examples 500A-500D illustrate multiplexing techniques that involve puncturing for HARQ-ACK bits in a UCI communication. More specifically, examples 500A-500D show an RB in a resource grid. The x-axis of the resource grid represents time (for example, in units of OFDM symbols), and the y-axis of the resource grid represents frequency (for example, in units of subcarriers). In some examples, a UE 120 may perform these techniques in preparation for transmission of the UCI communication.

With reference to FIG. 5A, example 500A shows REs (for example, time-frequency locations within the RB) mapped to various signals at a first time. REs 510 may be mapped to DMRS (for example, one or more DMRS symbols), REs 520 may be reserved for HARQ-ACK, and REs 530 may be mapped to CSI part 1. In some examples, the UE 120 may first map REs 510 to DMRS (for example, one or more DMRS symbols).

After mapping REs 510 to DMRS (for example, one or more DMRS symbols), the UE 120 may reserve REs 520 for HARQ-ACK. For example, the UE 120 may identify the reserved HARQ-ACK locations (for example, REs 520) in cases where the quantity of HARQ-ACK bits is less than or equal to 2. For instance, in examples 500A-500D, the quantity of HARQ-ACK bits may be less than or equal to 2, and therefore the UE 120 may reserve REs 520 for HARQ-ACK.

After reserving REs 520 for HARQ-ACK, the UE 120 may map REs 530 to CSI part 1. The UE 120 may map the CSI part 1 (for example, a coded CSI part 1) starting after a given quantity of the REs 520. The UE 120 may not map the CSI part 1 on the REs 520.

With reference to FIG. 5B, example 500B shows REs 540 mapped to CSI part 2. As shown, the UE 120 may map the CSI part 2 (for example, a coded CSI part 2) over REs 520 but not over the REs 530. For example, the REs 520 may be overlaid with the mapping to CSI part 2.

With reference to FIG. 5C, example 500C shows REs 550 mapped to data (for example, PUSCH, such as UL-SCH). For example, the UE 120 may map coded UL-SCH bits.

With reference to FIG. 5D, example 500D shows REs 560 mapped to HARQ-ACK. As shown, the UE 120 may map coded HARQ-ACK bits by puncturing the PUSCH (for example, CSI part 2) with the HARQ-ACK in at least some of the REs 520. After puncturing the CSI part 2, the UE 120 may form an OFDM symbol and transmit the UCI communication.

In some examples, such as where the quantity of HARQ-ACK bits is greater than 2, the UE 120 may rate-match the PUSCH with the HARQ-ACK. In such examples, the UE 120 may map the DMRS and then the HARQ-ACK (for example, the coded HARQ-ACK bits). After mapping the HARQ-ACK, the UE 120 may map CSI part 1. After mapping the CSI part 1, the UE 120 may map the CSI part 2. After mapping the CSI part 2, the UE 120 may map the data. The UE 120 may not map the CSI part 1, CSI part 2, or the data over the HARQ-ACK.

M_{sc}^{UL-SCH}(l)=|Φₗ^{UL-SCH}| may denote the number of elements in set Φₗ^{UL-SCH}. Φₗ^{UL-SCH}(j) may denote the j-th element in Φₗ^{UL-SCH}. N_{L} may be the number of transmission layers of the PUSCH, and Qₘ may be the modulation order of the PUSCH. Φₗ^{UCI} may denote the set of REs, in ascending order of indices k, available for transmission of UCI in OFDM symbol l, for l=0, 1, 2, . . . , N_{symb,all}^{PUSCH}−1. M_{sc}^{UCI}(l)=|Φₗ^{UCI}| may denote the number of elements in set Φₗ^{UCI}, Φₗ^{UCI}(j) may denote the j-th element in Φₗ^{UCI}. In some examples, for any OFDM symbol that carries a DMRS of the PUSCH, Φₗ^{UCI}=ø. In some examples, for any OFDM symbol that does not carry DMRS of the PUSCH, Φₗ^{UCI}=Φₗ^{UL-SCH}. If the number of HARQ-ACK information bits to be transmitted on PUSCH is 0, 1, or 2 bits and without CG-UCI, then the number of reserved REs for potential HARQ-ACK transmission may be calculated by setting O_{ACK}=2. G_{rvd}^{ACK} may denote the number of coded bits for potential HARQ-ACK transmission using the reserved resource elements. Φ̅ₗ^{rvd} may denote the set of reserved REs for potential HARQ-ACK transmission, in OFDM symbol l, for l=0, 1, 2, . . . , N_{symb,all}^{PUSCH}−1. This may result in uplink resource muting REs being excluded from available REs for UCI or being included in the reserved set if CSI part 2 and/or UL-SCH are punctured.

Non-transparent uplink resource muting may assist in performing accurate inter-node CLI measurements, such as estimating the interference covariance matrix (Rnn), which may be used in advanced network node receivers for suppressing interference. However, non-transparent uplink resource muting may impact techniques associated with uplink data (for example, UL-SCH) or UCI (for example, VRB mapping, resource identification, and UCI mapping, among other examples). For example, the VRBs assigned for transmission may not account for REs reserved for uplink resource muting. Additionally or alternatively, uplink resource muting REs may be excluded from available REs for UCI or included in the reserved set if CSI part 2 and/or UL-SCH are punctured. Without accounting for such impacts, non-transparent uplink resource muting may not support uplink data or UCI.

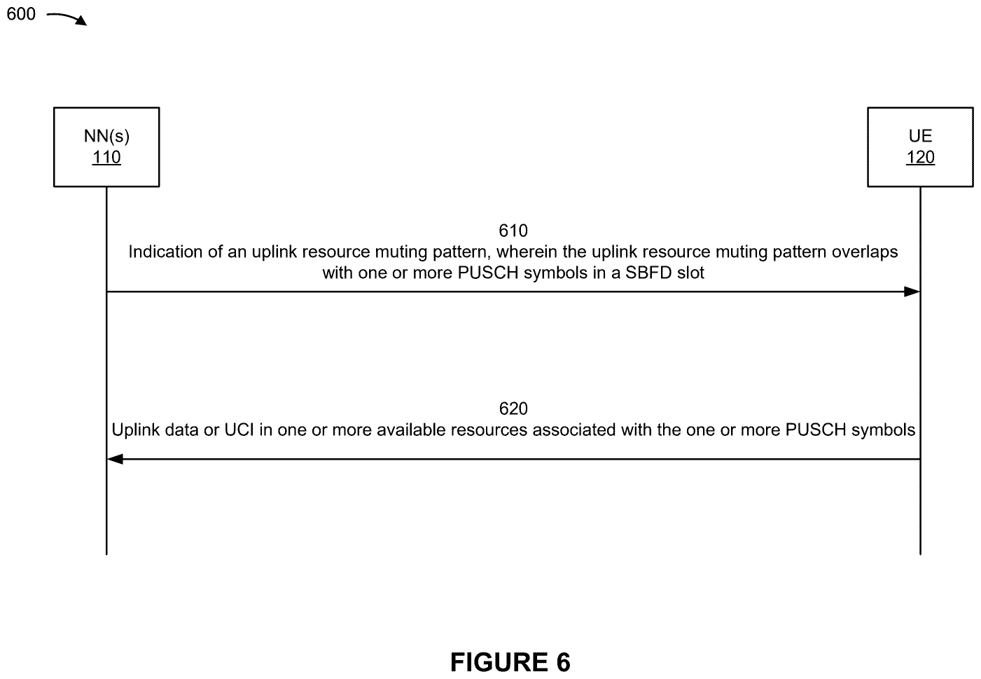

FIG. 6 is a diagram illustrating an example 600 associated with non-transparent uplink resource muting. As shown in FIG. 6, a network node 110 and a UE 120 may communicate with one another.

In a first operation 610, the network node 110 may transmit, and the UE 120 may receive, an indication of an uplink resource muting pattern. In some examples, the uplink resource muting pattern may be used for non-transparent uplink resource muting. The uplink resource muting pattern may be an RE-level muting pattern, and may be used for rate-matching and/or puncturing. The uplink resource muting pattern may overlap with one or more PUSCH symbols in an SBFD slot. For example, at least one resource in the uplink resource muting pattern may overlap with at least one of the PUSCH symbols.

In some aspects, the uplink resource muting pattern may not overlap with any DMRS symbols or REs, any PTRS symbols or REs, or any HARQ-ACK symbols or REs. For example, the uplink resource muting pattern may avoid REs or symbols dedicated to DMRS, PTRS, and/or HARQ-ACK. The uplink resource muting pattern may avoid REs or symbols dedicated to HARQ-ACK regardless of whether puncturing or rate-matching is used for HARQ.

In a second operation 620, the UE 120 may transmit, and the network node 110 may receive, in accordance with the uplink resource muting pattern, uplink data (for example, UL-SCH) or UCI in one or more available resources associated with the one or more PUSCH symbols. In some examples, the PUSCH symbols may be used to convey the uplink data or UCI. In some examples, the available resources may be available REs. The available resources may be associated with the one or more PUSCH symbols in that the available resources are conveyed in the PUSCH symbol(s).

In some aspects, transmitting the uplink data or the UCI may include rate-matching the uplink data and the UCI in accordance with the uplink resource muting pattern. For example, the UE 120 may use the uplink resource muting pattern to rate-match any information carried by PUSCH. For example, the UE 120 may use the uplink resource muting pattern to rate-match both uplink data (for example, UL-SCH) and UCI. Rate-matching may involve avoiding REs reserved for muting during RE mapping.

In some aspects, the one or more available resources are in virtual resource blocks that are not associated with the uplink resource muting pattern. For example, with respect to VRBs, for each of the antenna ports used for transmission of the PUSCH, the block of complex-valued symbols z^{(p)}(0), . . . , z^{(p)}(M_{symb}^{ap}−1) may be multiplied with the amplitude scaling factor β_{PUSCH} in order to conform to a specified transmit power and mapped in sequence starting with z^{(p)}(0) to REs (k′, l)_{p,μ} in the VRBs assigned for transmission that meet all of the following criteria: the VRBs are in the virtual resource blocks assigned for transmission; the corresponding REs in the corresponding physical RBs are not used for transmission of the associated DMRS, PTRS, or DMRS intended for other co-scheduled UEs; and the VRBs are not used by an uplink resource muting pattern. In some aspects, the uplink resource muting pattern may be an RE-level muting pattern or an RB-level muting pattern. In some aspects, the one or more available resources may include one or more symbol-dependent available resources that are associated with the UCI and do not include muted resources. For example, available PUSCH resources (for example, M_{sc}^{PUSCH}) may be symbol-dependent and exclude muted REs in examples where UCI resources are computed.

In some examples, uplink rate-matching patterns (for example, uplink resource muting patterns used for rate-matching) may be used to identify resources that are not available for PUSCH. For example, if uplink muting is allowed on symbols carrying UCI, then M_{sc}^{UCI}(l)=M_{SC}^{PUSCH}−M_{SC}^{PT-RS} (l). In some aspects, a first quantity of REs available for transmission of the UCI may be associated with a second quantity of REs available for uplink resource muting. For example, the first quantity of REs available for transmission of the UCI may be M_{SC}^{UCI}(l), and the second quantity of REs available for uplink resource muting may be M_{SC}^{mute}(l). The first quantity may be associated with the second quantity in that the first quantity may depend on (for example, be calculated based at least in part on) the second quantity. For example, if uplink muting is allowed on symbols carrying UCI, then M_{SC}^{UCI}(1)=M_{SC}^{PUSCH}−M_{SC}^{PT-RS} (l)−M_{SC}^{mute}(l).

In some aspects, a third quantity of subcarriers associated with a scheduled bandwidth of transmission of the uplink data or the UCI may be symbol-dependent. For example, the third quantity of subcarriers associated with the scheduled bandwidth of transmission of the uplink data or the UCI may be M_{SC}^{PUSCH}. When symbol-dependent, the third quantity may be M_{SC}^{PUSCH}(l). For example, if uplink muting is allowed on symbols carrying UCI, then M_{SC}^{UCI}(l)=M_{SC}^{PUSCH} (l)−M_{SC}^{PT-RS}(l).

In some aspects, the first quantity of REs available for transmission of the UCI may be associated with semi-static uplink resource muting patterns. For example, M_{SC}^{UCI}(l)=M_{SC}^{PUSCH}−M_{SC}^{PT-RS}(l)−M_{SC}^{mute}(l) or M_{SC}^{UCI}(l)=M_{SC}^{PUSCH}(l)−M_{SC}^{PT-RS}(l) may apply to semi-static muting patterns (for example, only semi-static muting patterns). In some aspects, the first quantity of REs available for transmission of the UCI may be associated with semi-static uplink resource muting patterns and dynamic uplink resource muting patterns. For example, M_{SC}^{UCI}(l)=M_{SC}^{PUSCH}−M_{SC}^{PT-RS} (l)−M_{sc}^{mute}(l) or M_{SC}^{UCI}(l)=M_{SC}^{PUSCH}(l)−M_{SC}^{PT-RS}(l) may be used for both dynamic muting and semi-static muting. In some examples, if muting is skipped when overlapping with UCI occurs, then M_{SC}^{UCI}(l)=M_{SC}^{PUSCH}−M_{SC}^{PT-RS}(l). In some examples, M_{SC}^{UCI}(l)=M_{SC}^{PUSCH}−M_{SC}^{PT-RS}(l)−M_{SC}^{mute}(l) or M_{SC}^{UCI}(l)=M_{SC}^{PUSCH}(l)−M_{SC}^{PT-RS}(l) may impact the REs in the set Φₗ^{UL-SCH}.

In some aspects, transmitting the uplink data or the UCI may include puncturing the uplink data and rate-matching the UCI in accordance with the uplink resource muting pattern. For example, the UE 120 may use the uplink resource muting pattern to rate-match UCI (for example, only UCI) and puncture at least some information carried by PUSCH (for example, UL-SCH). Puncturing may involve performing the RE mapping and then removing select REs for muting.

In some aspects, rate-matching the UCI includes rate-matching HARQ-ACK information, CSI part 1 information, and CSI part 2 information. For example, rate-matching may be used for all UCI and no uplink data (for example, UL-SCH). In some examples, uplink muting may be configured on symbols without UCI including HARQ-ACK, CSI part 1, and CSI part 2. For example, uplink muting may be configured on only symbols without UCI including HARQ-ACK, CSI part 1, and CSI part 2. In some examples, uplink muting may be configured on uplink data symbols (for example, UL-SCH symbols). For example, uplink muting may be configured on only UL-SCH.

In some examples (for example, where rate-matching is used for all UCI and no uplink data), the REs that are available for UCI may be redefined. In some aspects, a set of REs available for transmission of the uplink data may not include a set of REs available for uplink resource muting. The set of REs available for transmission of the uplink data may be Φₗ^{UL-SCH}, and the set of REs available for uplink resource muting may be Φₗ^{mute}. In some examples, for any OFDM symbol that does not carry DMRS of the PUSCH, Φₗ^{UCI}=Φₗ^{UL-SCH}, where ϕₗ^{mute} is excluded from ϕₗ^{UL-SCH}. Thus, the mapping rules for REs that are available for UCI may be updated. In some aspects, a quantity of REs available for transmission of the UCI may be associated with a quantity of the REs available for uplink resource muting. For example, the quantity of REs available for transmission of the UCI may be M_{SC}^{UCI}(l), and the quantity of REs available for uplink resource muting may be M_{SC}^{mute}(l). The quantity of REs available for transmission of the UCI may be associated with a quantity of the REs available for uplink resource muting in that the quantity of REs available for transmission of the UCI may depend on (for example, be calculated based at least in part on) the quantity of the REs available for uplink resource muting. In some examples, for any OFDM symbol that does not carry DMRS of the PUSCH, M_{SC}^{UCI}(l)=M_{SC}^{PUSCH}−M_{SC}^{PT-RS}(l)−M_{SC}^{mute}(l). Thus, the quantity of REs available for UCI when identifying the quantity of REs used for sending each UCI type may be updated. A UCI type may be HARQ-ACK information, CSI part 1 information, or CSI part 2 information, among other examples.

In some aspects, rate-matching the UCI may include rate-matching HARQ-ACK information and CSI part 1 information, and transmitting the uplink data or the UCI may further include puncturing CSI part 2 information. For example, rate-matching may be used for HARQ-ACK and CSI part 1, and puncturing may be used for CSI part 2. In some examples, uplink muting may be configured on symbols or REs without HARQ-ACK or CSI part 1. For example, uplink muting may be configured on only symbols without HARQ-ACK or CSI part 1. In some examples, uplink muting may be configured on symbols carrying uplink data (for example, UL-SCH) and/or CSI part 2. For example, uplink muting may be configured on only symbols carrying uplink data and/or CSI part 2.

In some aspects (for example, where rate-matching is used for HARQ-ACK and CSI part 1 and puncturing is used for CSI part 2), a first set of REs available for transmission of the HARQ-ACK information and the CSI part 1 information may not include a set of REs available for uplink resource muting from a set of REs available for transmission of the uplink data. The first set of REs, which may be denoted as ϕₗ^{UCI,set1} or UCI-RE-Set1, may be used for mapping HARQ-ACK and CSI part 1. In some examples, ϕₗ^{UCI,set1} may exclude the set of REs available for uplink resource muting (for example, ϕₗ^{mute}) from the set of REs available for transmission of the uplink data (for example, ϕₗ^{UL-SCH}).

In some aspects (for example, where rate-matching is used for HARQ-ACK and CSI part 1 and puncturing is used for CSI part 2), a second set of REs available for transmission of the CSI part 2 information may include the set of REs available for uplink resource muting from the set of REs available for transmission of the uplink data. The second set of REs, which may be denoted as ϕₗ^{UCI,set2} or UCI-RE-Set2, may be used for mapping CSI part 2. Thus, the first and second sets may be sets of REs that are available for UCI. In some examples, ϕₗ^{UCI,set2} may not exclude (for example, may include or potentially include) the set of REs available for uplink resource muting (for example, ϕₗ^{mute}) from the set of REs available for transmission of the uplink data (for example, ϕₗ^{UL-SCH}).

In some aspects (for example, where rate-matching is used for HARQ-ACK and CSI part 1 and puncturing is used for CSI part 2), a quantity of the REs available for transmission of the HARQ-ACK information and the CSI part 1 information may be associated with a quantity of the REs available for uplink resource muting. In some examples, for ϕₗ^{UCI,set1}, the quantity of REs available for transmission of the HARQ-ACK information and the CSI part 1 information may be M_{SC}^{UCI}(l), and the quantity of REs available for uplink resource muting may be M_{SC}^{mute}(l). The quantity of the REs available for transmission of the HARQ-ACK information and the CSI part 1 information may be associated with a quantity of the REs available for uplink resource muting in that the quantity of REs available for transmission of the HARQ-ACK information and the CSI part 1 information may depend on (for example, may be calculated based at least in part on) the quantity of the REs available for uplink resource muting. In some examples, for any OFDM symbol that does not carry DMRS of the PUSCH, M_{SC}^{UCI}(l)=M_{SC}^{PUSCH}−M_{SC}^{PT-RS}(l)−M_{SC}^{mute}(l). In some examples, for ϕₗ^{UCI,set2}, the quantity of REs available for transmission of the CSI part 2 information may be M_{SC}^{UCI}(l), and M_{SC}^{UCI}(l)=M_{SC}^{PUSCH}−M_{SC}^{PT-RS}(l) for any OFDM symbol that does not carry DMRS of the PUSCH.

In some aspects, rate-matching the UCI may include rate-matching HARQ-ACK information, and transmitting the uplink data or the UCI may further include puncturing CSI part 1 information and CSI part 2 information. In some examples, uplink muting may be configured on symbols or REs without HARQ-ACK. For example, uplink muting may be configured on only symbols without HARQ-ACK. In some examples, REs reserved for HARQ-ACK may be avoided. For example, only REs reserved for HARQ-ACK may be avoided.

In some aspects (for example, where uplink muting is configured on only symbols without HARQ-ACK), a first set of REs available for transmission of the HARQ-ACK information may not include a set of REs available for uplink resource muting in a set of REs available for transmission of the uplink data. The first set of REs, which in this example may be denoted as ϕₗ^{UCI,set1} or UCI-RE-Set1, may be used for mapping HARQ-ACK. In some examples, ϕₗ^{UCI,set1} may exclude the set of REs available for uplink resource muting (for example, ϕₗ^{mute}) from the set of REs available for transmission of the uplink data (for example, ϕₗ^{UL-SCH}).

In some aspects (for example, where uplink muting is configured on only symbols without HARQ-ACK), a second set of REs available for transmission of the CSI part 1 information or the CSI part 2 information may include the set of REs available for uplink resource muting in the set of REs available for transmission of the uplink data. The second set of REs, which in this example may be denoted as ϕₗ^{UCI,set2} or UCI-RE-Set2, may be used for mapping CSI part 1 and CSI part 2. Thus, the first and second sets may be sets of REs that are available for UCI. In some examples, ϕₗ^{UCI,set2} may not exclude the set of REs available for uplink resource muting (for example, ϕₗ^{mute}) from the set of REs available for transmission of the uplink data (for example, ϕₗ^{UL-SCH}).

In some aspects, the UE 120 may puncture the CSI part 1 information in accordance with a quantity of punctured available REs satisfying a punctured available RE threshold. For example, the punctured available REs may carry the CSI part 1 information. If the quantity of punctured available REs satisfies (for example, is less than) the punctured available RE threshold, then the UE 120 may puncture the CSI part 1 information. If the quantity of punctured available REs does not satisfy (for example, exceeds) the punctured available RE threshold, then the UE 120 may drop a CSI report (for example, a whole CSI report) associated with the CSI part 1 information. Thus, in some examples, the CSI part 1 information and/or CSI part 2 information may be punctured or dropped.

In some examples, uplink muting may be used for puncturing at least some of the REs used for UL-SCH (for example, uplink data) or CSI information (for example, CSI part 1 information and/or CSI part 2 information). The uplink muting may avoid hybrid automatic repeat request (HARQ) REs. In such examples, a total quantity of punctured REs may be restricted and/or uplink muting may be skipped.

In some aspects (for example, where uplink muting is used for puncturing at least some of the REs used for UL-SCH or CSI information), the UE 120 may skip uplink muting associated with the uplink resource muting pattern in accordance with a quantity of punctured REs satisfying a punctured RE threshold. For example, the UE 120 may restrict the total quantity of punctured REs if the quantity of punctured REs exceeds the punctured RE threshold. The UE 120 may skip the uplink muting associated with the uplink resource muting pattern in that the UE 120 may skip muting on one or more uplink resources included in the uplink resource muting pattern. In some aspects, the punctured RE threshold may be a UCI-type-based threshold (for example, the punctured RE threshold may be defined separately for each UCI type) or a per-symbol threshold (for example, the punctured RE threshold may be defined per symbol).

In some examples, the UE 120 may skip uplink muting on (for example, avoid) certain symbols. In some aspects (for example, where uplink muting is used for puncturing at least some of the REs used for UL-SCH or CSI information), the UE 120 may skip uplink muting associated with the uplink resource muting pattern on one or more initial symbols of a PUSCH communication that carries the uplink data or the UCI. For example, the UE 120 may avoid the first X symbols (for example, where X=3) in a PUSCH (for example, a PUSCH that carries UCI). If frequency hopping is enabled, then the UE 120 may avoid the first X symbols in the PUSCH on each hop. In some aspects, the UE 120 may skip the uplink muting on one or more symbols in accordance with a priority associated with the UCI. For example, the UE 120 may avoid high-priority UCI, among other examples.

In some examples, TB size for PUSCH with muting may be calculated using an xOverhead parameter to capture the impact of muting. For example, the UE 120 may first identify the number of REs allocated for PUSCH within a physical RB (PRB) (N′_{RE}). In some examples, N′_{RE}=N_{SC}^{RB}·N_{symb}^{sh}−N_{DMRS}^{PRB}−Nₒₕ^{PRB}, where N_{SC}^{RB}=12 may be the number of subcarriers in the frequency domain in a physical resource block, N_{symb}^{sh} may be the number of symbols L of the PUSCH allocation for scheduled PUSCH or configured PUSCH, N_{DMRS}^{PRB} may be the number of REs for DMRS per PRB in the allocated duration including the overhead of the DMRS code division multiplexing (CDM) groups without data, for PUSCH with a configured grant, as indicated by DCI format 0_1, 0_2 or 0_3, or for DCI format 0_0, and Nₒₕ^{PRB} may be the overhead configured by higher layer parameter xOverhead in PUSCH-ServingCellConfig. 1f the Nₒₕ^{PRB} is not configured (for example, a value from 6, 12, or 18), then the Nₒₕ^{PRB} may be assumed to be 0. For Msg3 or MsgA PUSCH transmissions, the Nₒₕ^{PRB} may be set to 0. In case of PUSCH repetition Type B, N_{DMRS}^{PRB} may be identified assuming a nominal repetition with the duration of L symbols without segmentation.

Transmitting or receiving, in accordance with the uplink resource muting pattern, the uplink data or UCI in one or more available resources associated with the one or more PUSCH symbols, may enable uplink resource muting (for example, non-transparent uplink resource muting) to support uplink data or UCI. As a result, uplink resource muting may assist in performing accurate inter-node CLI measurements to suppress interference in cases where the UE 120 is to transmit a PUSCH communication.

Rate-matching the uplink data and the UCI in accordance with the uplink resource muting pattern may help to ensure that the uplink data and the UCI are transmitted with high reliability.

Puncturing the uplink data and rate-matching the UCI in accordance with the uplink resource muting pattern may reduce complexity at the UE 120 by avoiding rate-matching of uplink data and maintain high reliability for at least certain UCI types.

Rate-matching HARQ-ACK information, CSI part 1 information, and CSI part 2 information may reduce complexity at the UE 120 by avoiding rate-matching of uplink data and maintain high reliability for HARQ-ACK information, CSI part 1 information, and CSI part 2 information.

Rate-matching HARQ-ACK information and CSI part 1 information and puncturing CSI part 2 information may further reduce complexity at the UE 120 by avoiding rate-matching of uplink data and CSI part 2 information and maintain high reliability for HARQ-ACK information and CSI part 1 information.

Rate-matching HARQ-ACK information and puncturing CSI part 1 information and CSI part 2 information may further reduce complexity at the UE 120 by avoiding rate-matching of uplink data, CSI part 1 information, and CSI part 2 information and maintain high reliability for HARQ-ACK information.

The uplink resource muting pattern not overlapping with any DMRS symbols or REs, any PTRS symbols or REs, or any HARQ-ACK symbols or REs may provide general restrictions on the uplink muting pattern that protect important (for example, DMRS, PTRS, or HARQ-ACK) symbols or REs in the PUSCH.

FIG. 7 is a flowchart illustrating an example process 700 performed, for example, at a UE or an apparatus of a UE that supports uplink data or UCI with an uplink resource muting pattern. Example process 700 is an example where the apparatus or the UE (for example, UE 120) performs operations associated with uplink data or UCI with an uplink resource muting pattern.

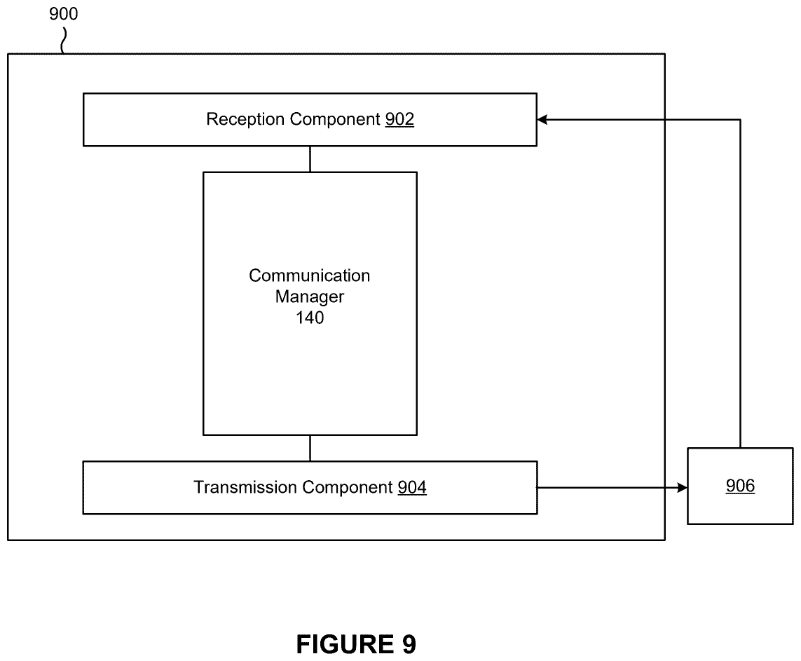

As shown in FIG. 7, in some aspects, process 700 may include receiving an indication of an uplink resource muting pattern, wherein the uplink resource muting pattern overlaps with one or more PUSCH symbols in an SBFD slot (block 710). For example, the UE (such as by using communication manager 140 or reception component 902, depicted in FIG. 9) may receive an indication of an uplink resource muting pattern, wherein the uplink resource muting pattern overlaps with one or more PUSCH symbols in an SBFD slot, as described above.

As further shown in FIG. 7, in some aspects, process 700 may include transmitting, in accordance with the uplink resource muting pattern, uplink data or UCI in one or more available resources associated with the one or more PUSCH symbols (block 720). For example, the UE (such as by using communication manager 140 or transmission component 904, depicted in FIG. 9) may transmit, in accordance with the uplink resource muting pattern, uplink data or UCI in one or more available resources associated with the one or more PUSCH symbols, as described above.

Process 700 may include additional aspects, such as any single aspect or any combination of aspects described below or in connection with one or more other processes described elsewhere herein.

In a first additional aspect, transmitting the uplink data or the UCI includes rate-matching the uplink data and the UCI in accordance with the uplink resource muting pattern.

In a second additional aspect, alone or in combination with the first aspect, the one or more available resources are in virtual resource blocks that are not associated with the uplink resource muting pattern, the uplink resource muting pattern is a resource-element-level muting pattern or a resource-block-level muting pattern, and the one or more available resources include one or more symbol-dependent available resources that are associated with the UCI and do not include muted resources.

In a third additional aspect, alone or in combination with one or more of the first and second aspects, a first quantity of REs available for transmission of the UCI is associated with a second quantity of REs available for uplink resource muting, or a third quantity of subcarriers associated with a scheduled bandwidth of transmission of the uplink data or the UCI is symbol-dependent, and the first quantity of REs available for transmission of the UCI is associated with semi-static uplink resource muting patterns.

In a fourth additional aspect, alone or in combination with one or more of the first through third aspects, a first quantity of REs available for transmission of the UCI is associated with a second quantity of REs available for uplink resource muting, or a third quantity of subcarriers associated with a scheduled bandwidth of transmission of the uplink data or the UCI is symbol-dependent, and the first quantity of REs available for transmission of the UCI is associated with semi-static uplink resource muting patterns and dynamic uplink resource muting patterns.

In a fifth additional aspect, alone or in combination with one or more of the first through fourth aspects, transmitting the uplink data or the UCI includes puncturing the uplink data and rate-matching the UCI in accordance with the uplink resource muting pattern.

In a sixth additional aspect, alone or in combination with one or more of the first through fifth aspects, rate-matching the UCI includes rate-matching HARQ-ACK information, CSI part 1 information, and CSI part 2 information.

In a seventh additional aspect, alone or in combination with one or more of the first through sixth aspects, a set of REs available for transmission of the uplink data does not include a set of REs available for uplink resource muting, and a quantity of REs available for transmission of the UCI is associated with a quantity of the REs available for uplink resource muting.

In an eighth additional aspect, alone or in combination with one or more of the first through seventh aspects, rate-matching the UCI includes rate-matching HARQ-ACK information and CSI part 1 information, and transmitting the uplink data or the UCI further includes puncturing CSI part 2 information.

In a ninth additional aspect, alone or in combination with one or more of the first through eighth aspects, a first set of REs available for transmission of the HARQ-ACK information and the CSI part 1 information does not include a set of REs available for uplink resource muting in a set of REs available for transmission of the uplink data, a second set of REs available for transmission of the CSI part 2 information includes the set of REs available for uplink resource muting in the set of REs available for transmission of the uplink data, and a quantity of the REs available for transmission of the HARQ-ACK information and the CSI part 1 information is associated with a quantity of the REs available for uplink resource muting.

In a tenth additional aspect, alone or in combination with one or more of the first through ninth aspects, rate-matching the UCI includes rate-matching HARQ-ACK information, and transmitting the uplink data or the UCI further includes puncturing CSI part 1 information and CSI part 2 information.

In an eleventh additional aspect, alone or in combination with one or more of the first through tenth aspects, puncturing the CSI part 1 information includes puncturing the CSI part 1 information in accordance with a quantity of punctured available REs satisfying a punctured available RE threshold.

In a twelfth additional aspect, alone or in combination with one or more of the first through eleventh aspects, a first set of REs available for transmission of the HARQ-ACK information does not include a set of REs available for uplink resource muting in a set of REs available for transmission of the uplink data, and a second set of REs available for transmission of the CSI part 1 information and the CSI part 2 information includes the set of REs available for uplink resource muting in the set of REs available for transmission of the uplink data.

In a thirteenth additional aspect, alone or in combination with one or more of the first through twelfth aspects, the uplink resource muting pattern does not overlap with any DMRS symbols or REs, any PTRS symbols or REs, or any HARQ-ACK symbols or REs.

In a fourteenth additional aspect, alone or in combination with one or more of the first through thirteenth aspects, transmitting the uplink data or the UCI includes skipping uplink muting associated with the uplink resource muting pattern in accordance with a quantity of punctured REs satisfying a punctured RE threshold, and the punctured RE threshold is a UCI-type-based threshold or a per-symbol threshold.

In a fifteenth additional aspect, alone or in combination with one or more of the first through fourteenth aspects, transmitting the uplink data or the UCI includes skipping uplink muting associated with the uplink resource muting pattern on one or more initial symbols of a PUSCH communication that carries the uplink data or the UCI, or skipping the uplink muting on one or more symbols in accordance with a priority associated with the UCI.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, at a network node or an apparatus of a network node that supports uplink data or UCI with an uplink resource muting pattern. Example process 800 is an example where the apparatus or the network node (for example, network node 110) performs operations associated with uplink data or UCI with an uplink resource muting pattern.

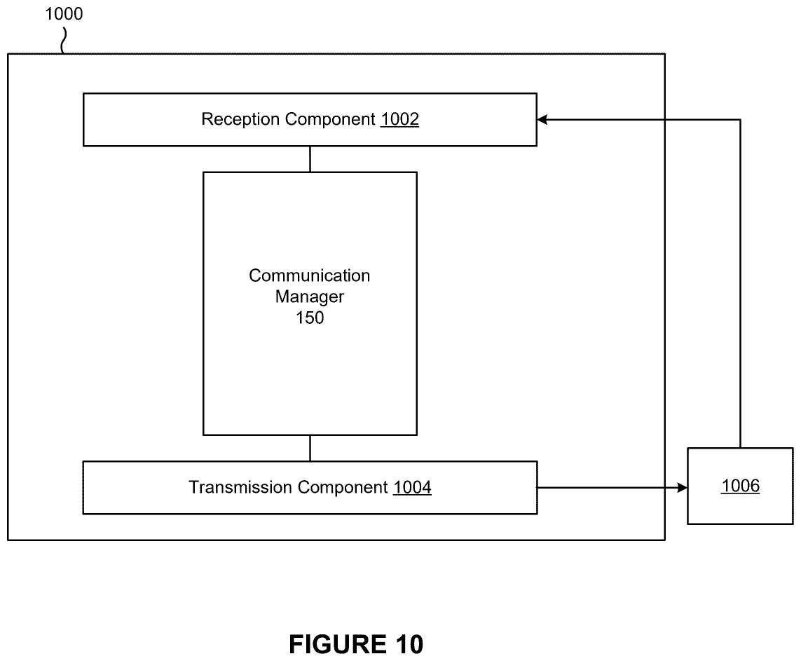

As shown in FIG. 8, in some aspects, process 800 may include transmitting an indication of an uplink resource muting pattern, wherein the uplink resource muting pattern overlaps with one or more PUSCH symbols in an SBFD slot (block 810). For example, the network node (such as by using communication manager 150 or transmission component 1004, depicted in FIG. 10) may transmit an indication of an uplink resource muting pattern, wherein the uplink resource muting pattern overlaps with one or more PUSCH symbols in an SBFD slot, as described above.

As further shown in FIG. 8, in some aspects, process 800 may include receiving, in accordance with the uplink resource muting pattern, uplink data or UCI in one or more available resources associated with the one or more PUSCH symbols (block 820). For example, the network node (such as by using communication manager 150 or reception component 1002, depicted in FIG. 10) may receive, in accordance with the uplink resource muting pattern, uplink data or UCI in one or more available resources associated with the one or more PUSCH symbols, as described above.

Process 800 may include additional aspects, such as any single aspect or any combination of aspects described below or in connection with one or more other processes described elsewhere herein.

In a first additional aspect, the uplink data and the UCI are rate-matched in accordance with the uplink resource muting pattern.

In a second additional aspect, alone or in combination with the first aspect, the one or more available resources are in virtual resource blocks that are not associated with the uplink resource muting pattern, the uplink resource muting pattern is a resource-element-level muting pattern or a resource-block-level muting pattern, and the one or more available resources include one or more symbol-dependent available resources that are associated with the UCI and do not include muted resources.

In a third additional aspect, alone or in combination with one or more of the first and second aspects, a first quantity of REs available for transmission of the UCI is associated with a second quantity of REs available for uplink resource muting, or a third quantity of subcarriers associated with a schedule bandwidth of transmission of the uplink data or the UCI is symbol-dependent, and the first quantity of REs available for transmission of the UCI is associated with semi-static uplink resource muting patterns.

In a fourth additional aspect, alone or in combination with one or more of the first through third aspects, a first quantity of REs available for transmission of the UCI is associated with a second quantity of REs available for uplink resource muting, or a third quantity of subcarriers associated with a scheduled bandwidth of transmission of the uplink data or the UCI is symbol-dependent, and the first quantity of REs available for transmission of the UCI is associated with semi-static uplink resource muting patterns and dynamic uplink resource muting patterns.

In a fifth additional aspect, alone or in combination with one or more of the first through fourth aspects, the uplink data is punctured and the UCI is rate-matched in accordance with the uplink resource muting pattern.

In a sixth additional aspect, alone or in combination with one or more of the first through fifth aspects, HARQ-ACK information of the UCI, CSI part 1 information of the UCI, and CSI part 2 information of the UCI are rate-matched.

In a seventh additional aspect, alone or in combination with one or more of the first through sixth aspects, a set of REs available for transmission of the uplink data does not include a set of REs available for uplink resource muting, and a quantity of REs available for transmission of the UCI is associated with a quantity of the REs available for uplink resource muting.

In an eighth additional aspect, alone or in combination with one or more of the first through seventh aspects, HARQ-ACK information of the UCI and CSI part 1 information of the UCI are rate-matched, and CSI part 2 information of the UCI is punctured.

In a ninth additional aspect, alone or in combination with one or more of the first through eighth aspects, a first set of REs available for transmission of the HARQ-ACK information and the CSI part 1 information does not include a set of REs available for uplink resource muting in a set of REs available for transmission of the uplink data, a second set of REs available for transmission of the CSI part 2 information includes the set of REs available for uplink resource muting in the set of REs available for transmission of the uplink data, and a quantity of the REs available for transmission of the HARQ-ACK information and the CSI part 1 information is associated with a quantity of the REs available for uplink resource muting.

In a tenth additional aspect, alone or in combination with one or more of the first through ninth aspects, HARQ-ACK information of the UCI is rate-matched, and CSI part 1 information of the UCI and CSI part 2 information of the UCI are punctured.

In an eleventh additional aspect, alone or in combination with one or more of the first through tenth aspects, the CSI part 1 information is punctured in accordance with a quantity of punctured available REs satisfying a punctured available RE threshold.

In a twelfth additional aspect, alone or in combination with one or more of the first through eleventh aspects, a first set of REs available for transmission of the HARQ-ACK information does not include a set of REs available for uplink resource muting in a set of REs available for transmission of the uplink data, and a second set of REs available for transmission of the CSI part 1 information and the CSI part 2 information includes the set of REs available for uplink resource muting in the set of REs available for transmission of the uplink data.

In a thirteenth additional aspect, alone or in combination with one or more of the first through twelfth aspects, the uplink resource muting pattern does not overlap with any DMRS symbols or REs, any PTRSs symbols or REs, or any HARQ-ACK symbols or REs.

In a fourteenth additional aspect, alone or in combination with one or more of the first through thirteenth aspects, uplink muting associated with the uplink resource muting pattern is skipped in accordance with a quantity of punctured REs satisfying a punctured RE threshold, and the punctured RE threshold is a UCI-type-based threshold or a per-symbol threshold.

In a fifteenth additional aspect, alone or in combination with one or more of the first through fourteenth aspects, uplink muting associated with the uplink resource muting pattern is skipped on one or more initial symbols of a PUSCH communication that carries the uplink data or the UCI, or the uplink muting is skipped on one or more symbols in accordance with a priority associated with the UCI.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports uplink data or UCI with an uplink resource muting pattern. The apparatus 900 may be a UE, or a UE may include the apparatus 900. In some aspects, the apparatus 900 includes a reception component 902, a transmission component 904, and a communication manager 140, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to and/or operable to perform one or more operations described herein in connection with FIG. 6. Additionally or alternatively, the apparatus 900 may be configured to and/or operable to perform one or more processes described herein, such as process 700 of FIG. 7. In some aspects, the apparatus 900 may include one or more components of the UE described above in connection with FIG. 2.

The reception component 902 may receive communications, such as reference signals, control information, and/or data communications, from the apparatus 906. The reception component 902 may provide received communications to one or more other components of the apparatus 900, such as the communication manager 140. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, one or more modems, one or more demodulators, one or more MIMO detectors, one or more receive processors, one or more controllers/processors, and/or one or more memories of the UE described above in connection with FIG. 2.

The transmission component 904 may transmit communications, such as reference signals, control information, and/or data communications, to the apparatus 906. In some aspects, the communication manager 140 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 904 may be co-located with the reception component 902 in one or more transceivers.

The communication manager 140 may receive or may cause the reception component 902 to receive an indication of an uplink resource muting pattern, wherein the uplink resource muting pattern overlaps with one or more PUSCH symbols in an SBFD slot. The communication manager 140 may transmit or may cause the transmission component 904 to transmit, in accordance with the uplink resource muting pattern, uplink data or UCI in one or more available resources associated with the one or more PUSCH symbols. In some aspects, the communication manager 140 may perform one or more operations described elsewhere herein as being performed by one or more components of the communication manager 140. The communication manager 140 may include one or more controllers/processors and/or one or more memories of the UE described above in connection with FIG. 2.

The reception component 902 may receive an indication of an uplink resource muting pattern, wherein the uplink resource muting pattern overlaps with one or more PUSCH symbols in an SBFD slot. The transmission component 904 may transmit, in accordance with the uplink resource muting pattern, uplink data or UCI in one or more available resources associated with the one or more PUSCH symbols.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a diagram of an example apparatus 1000 for wireless communication that supports uplink data or UCI with an uplink resource muting pattern. The apparatus 1000 may be a network node, or a network node may include the apparatus 1000. In some aspects, the apparatus 1000 includes a reception component 1002, a transmission component 1004, and a communication manager 150, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to and/or operable to perform one or more operations described herein in connection with FIG. 6. Additionally or alternatively, the apparatus 1000 may be configured to and/or operable to perform one or more processes described herein, such as process 800 of FIG. 8. In some aspects, the apparatus 1000 may include one or more components of the network node described above in connection with FIG. 2.

The reception component 1002 may receive communications, such as reference signals, control information, and/or data communications, from the apparatus 1006. The reception component 1002 may provide received communications to one or more other components of the apparatus 1000, such as the communication manager 150. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, one or more modems, one or more demodulators, one or more MIMO detectors, one or more receive processors, one or more controllers/processors, and/or one or more memories of the network node described above in connection with FIG. 2.

The transmission component 1004 may transmit communications, such as reference signals, control information, and/or data communications, to the apparatus 1006. In some aspects, the communication manager 150 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 1004 may be co-located with the reception component 1002 in one or more transceivers.

The communication manager 150 may transmit or may cause the transmission component 1004 to transmit an indication of an uplink resource muting pattern, wherein the uplink resource muting pattern overlaps with one or more PUSCH symbols in an SBFD slot. The communication manager 150 may receive or may cause the reception component 1002 to receive, in accordance with the uplink resource muting pattern, uplink data or UCI in one or more available resources associated with the one or more PUSCH symbols. In some aspects, the communication manager 150 may perform one or more operations described elsewhere herein as being performed by one or more components of the communication manager 150. The communication manager 150 may include one or more controllers/processors, one or more memories, one or more schedulers, and/or one or more communication units of the network node described above in connection with FIG. 2.

The transmission component 1004 may transmit an indication of an uplink resource muting pattern, wherein the uplink resource muting pattern overlaps with one or more PUSCH symbols in an SBFD slot. The reception component 1002 may receive, in accordance with the uplink resource muting pattern, uplink data or UCI in one or more available resources associated with the one or more PUSCH symbols.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: receiving an indication of an uplink resource muting pattern, wherein the uplink resource muting pattern overlaps with one or more PUSCH symbols in an SBFD slot; and transmitting, in accordance with the uplink resource muting pattern, uplink data or UCI in one or more available resources associated with the one or more PUSCH symbols.

Aspect 2: The method of Aspect 1, wherein transmitting the uplink data or the UCI includes: rate-matching the uplink data and the UCI in accordance with the uplink resource muting pattern.

Aspect 3: The method of Aspect 2, wherein the one or more available resources are in virtual resource blocks that are not associated with the uplink resource muting pattern, wherein the uplink resource muting pattern is a resource-element-level muting pattern or a resource-block-level muting pattern, and wherein the one or more available resources include one or more symbol-dependent available resources that are associated with the UCI and do not include muted resources.

Aspect 4: The method of Aspect 2, wherein a first quantity of REs available for transmission of the UCI is associated with a second quantity of REs available for uplink resource muting, or wherein a third quantity of subcarriers associated with a scheduled bandwidth of transmission of the uplink data or the UCI is symbol-dependent, and wherein the first quantity of REs available for transmission of the UCI is associated with semi-static uplink resource muting patterns.

Aspect 5: The method of Aspect 2, wherein a first quantity of REs available for transmission of the UCI is associated with a second quantity of REs available for uplink resource muting, or wherein a third quantity of subcarriers associated with a scheduled bandwidth of transmission of the uplink data or the UCI is symbol-dependent, and wherein the first quantity of REs available for transmission of the UCI is associated with semi-static uplink resource muting patterns and dynamic uplink resource muting patterns.

Aspect 6: The method of any of Aspects 1-5, wherein transmitting the uplink data or the UCI includes: puncturing the uplink data and rate-matching the UCI in accordance with the uplink resource muting pattern.

Aspect 7: The method of Aspect 6, wherein rate-matching the UCI includes rate-matching HARQ-ACK information, CSI part 1 information, and CSI part 2 information.

Aspect 8: The method of Aspect 7, wherein a set of REs available for transmission of the uplink data does not include a set of REs available for uplink resource muting, and wherein a quantity of REs available for transmission of the UCI is associated with a quantity of the REs available for uplink resource muting.

Aspect 9: The method of Aspect 6, wherein rate-matching the UCI includes rate-matching HARQ-ACK information and CSI part 1 information, and wherein transmitting the uplink data or the UCI further includes: puncturing CSI part 2 information.

Aspect 10: The method of Aspect 9, wherein a first set of REs available for transmission of the HARQ-ACK information and the CSI part 1 information does not include a set of REs available for uplink resource muting in a set of REs available for transmission of the uplink data, wherein a second set of REs available for transmission of the CSI part 2 information includes the set of REs available for uplink resource muting in the set of REs available for transmission of the uplink data, and wherein a quantity of the REs available for transmission of the HARQ-ACK information and the CSI part 1 information is associated with a quantity of the REs available for uplink resource muting.

Aspect 11: The method of Aspect 6, wherein rate-matching the UCI includes rate-matching HARQ-ACK information, and wherein transmitting the uplink data or the UCI further includes: puncturing CSI part 1 information and CSI part 2 information.

Aspect 12: The method of Aspect 11, wherein puncturing the CSI part 1 information includes puncturing the CSI part 1 information in accordance with a quantity of punctured available REs satisfying a punctured available RE threshold.

Aspect 13: The method of Aspect 11, wherein a first set of REs available for transmission of the HARQ-ACK information does not include a set of REs available for uplink resource muting in a set of REs available for transmission of the uplink data, and

wherein a second set of REs available for transmission of the CSI part 1 information and the CSI part 2 information includes the set of REs available for uplink resource muting in the set of REs available for transmission of the uplink data.

Aspect 14: The method of any of Aspects 1-13, wherein the uplink resource muting pattern does not overlap with any DMRS symbols or REs, any PTRS symbols or REs, or any HARQ-ACK symbols or REs.

Aspect 15: The method of any of Aspects 1-14, wherein transmitting the uplink data or the UCI includes: skipping uplink muting associated with the uplink resource muting pattern in accordance with a quantity of punctured REs satisfying a punctured RE threshold, wherein the punctured RE threshold is a UCI-type-based threshold or a per-symbol threshold.

Aspect 16: The method of any of Aspects 1-15, wherein transmitting the uplink data or the UCI includes: skipping uplink muting associated with the uplink resource muting pattern on one or more initial symbols of a PUSCH communication that carries the uplink data or the UCI, or skipping the uplink muting on one or more symbols in accordance with a priority associated with the UCI.

Aspect 17: A method of wireless communication performed by a network node, comprising: transmitting an indication of an uplink resource muting pattern, wherein the uplink resource muting pattern overlaps with one or more PUSCH symbols in an SBFD slot; and receiving, in accordance with the uplink resource muting pattern, uplink data or UCI in one or more available resources associated with the one or more PUSCH symbols.

Aspect 18: The method of Aspect 17, wherein the uplink data and the UCI are rate-matched in accordance with the uplink resource muting pattern.

Aspect 19: The method of Aspect 18, wherein the one or more available resources are in virtual resource blocks that are not associated with the uplink resource muting pattern, wherein the uplink resource muting pattern is a resource-element-level muting pattern or a resource-block-level muting pattern, and wherein the one or more available resources include one or more symbol-dependent available resources that are associated with the UCI and do not include muted resources.

Aspect 20: The method of Aspect 18, wherein a first quantity of REs available for transmission of the UCI is associated with a second quantity of REs available for uplink resource muting, or wherein a third quantity of subcarriers associated with a schedule bandwidth of transmission of the uplink data or the UCI is symbol-dependent, and wherein the first quantity of REs available for transmission of the UCI is associated with semi-static uplink resource muting patterns.

Aspect 21: The method of Aspect 18, wherein a first quantity of REs available for transmission of the UCI is associated with a second quantity of REs available for uplink resource muting, or wherein a third quantity of subcarriers associated with a scheduled bandwidth of transmission of the uplink data or the UCI is symbol-dependent, and wherein the first quantity of REs available for transmission of the UCI is associated with semi-static uplink resource muting patterns and dynamic uplink resource muting patterns.

Aspect 22: The method of any of Aspects 17-21, wherein the uplink data is punctured and the UCI is rate-matched in accordance with the uplink resource muting pattern.

Aspect 23: The method of Aspect 22, wherein HARQ-ACK information of the UCI, CSI part 1 information of the UCI, and CSI part 2 information of the UCI are rate-matched.

Aspect 24: The method of Aspect 23, wherein a set of REs available for transmission of the uplink data does not include a set of REs available for uplink resource muting, and wherein a quantity of REs available for transmission of the UCI is associated with a quantity of the REs available for uplink resource muting.

Aspect 25: The method of Aspect 22, wherein HARQ-ACK information of the UCI and CSI part 1 information of the UCI are rate-matched, and wherein CSI part 2 information of the UCI is punctured.

Aspect 26: The method of Aspect 25, wherein a first set of REs available for transmission of the HARQ-ACK information and the CSI part 1 information does not include a set of REs available for uplink resource muting in a set of REs available for transmission of the uplink data, wherein a second set of REs available for transmission of the CSI part 2 information includes the set of REs available for uplink resource muting in the set of REs available for transmission of the uplink data, and wherein a quantity of the REs available for transmission of the HARQ-ACK information and the CSI part 1 information is associated with a quantity of the REs available for uplink resource muting.

Aspect 27: The method of Aspect 22, wherein HARQ-ACK information of the UCI is rate-matched, and wherein CSI part 1 information of the UCI and CSI part 2 information of the UCI are punctured.

Aspect 28: The method of Aspect 27, the CSI part 1 information is punctured in accordance with a quantity of punctured available REs satisfying a punctured available RE threshold.

Aspect 29: The method of Aspect 27, wherein a first set of REs available for transmission of the HARQ-ACK information does not include a set of REs available for uplink resource muting in a set of REs available for transmission of the uplink data, and

wherein a second set of REs available for transmission of the CSI part 1 information and the CSI part 2 information includes the set of REs available for uplink resource muting in the set of REs available for transmission of the uplink data.

Aspect 30: The method of any of Aspects 17-29, wherein the uplink resource muting pattern does not overlap with any DMRS symbols or REs, any PTRSs symbols or REs, or any HARQ-ACK symbols or REs.

Aspect 31: The method of any of Aspects 17-30, wherein uplink muting associated with the uplink resource muting pattern is skipped in accordance with a quantity of punctured REs satisfying a punctured RE threshold, and wherein the punctured RE threshold is a UCI-type-based threshold or a per-symbol threshold.

Aspect 32: The method of any of Aspects 17-31, wherein uplink muting associated with the uplink resource muting pattern is skipped on one or more initial symbols of a PUSCH communication that carries the uplink data or the UCI, or the uplink muting is skipped on one or more symbols in accordance with a priority associated with the UCI.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive an indication of an uplink resource muting pattern, wherein the uplink resource muting pattern overlaps with one or more physical uplink shared channel (PUSCH) symbols in a sub-band full duplex (SBFD) slot; and
transmit, in accordance with the uplink resource muting pattern, uplink data or uplink control information (UCI) in one or more available resources associated with the one or more PUSCH symbols.

2. The apparatus of claim 1, wherein the at least one processor, to cause the UE to transmit the uplink data or the UCI, is configured to cause the UE to:
rate-match the uplink data and the UCI in accordance with the uplink resource muting pattern.

3. The apparatus of claim 2, wherein the one or more available resources are in virtual resource blocks that are not associated with the uplink resource muting pattern, wherein the uplink resource muting pattern is a resource-element-level muting pattern or a resource-block-level muting pattern, and wherein the one or more available resources include one or more symbol-dependent available resources that are associated with the UCI and do not include muted resources.

4. The apparatus of claim 2, wherein a first quantity of resource elements (REs) available for transmission of the UCI is associated with a second quantity of REs available for uplink resource muting, or wherein a third quantity of subcarriers associated with a scheduled bandwidth of transmission of the uplink data or the UCI is symbol-dependent, and
wherein the first quantity of REs available for transmission of the UCI is associated with semi-static uplink resource muting patterns.

5. The apparatus of claim 2, wherein a first quantity of resource elements (REs) available for transmission of the UCI is associated with a second quantity of REs available for uplink resource muting, or wherein a third quantity of subcarriers associated with a scheduled bandwidth of transmission of the uplink data or the UCI is symbol-dependent, and
wherein the first quantity of REs available for transmission of the UCI is associated with semi-static uplink resource muting patterns and dynamic uplink resource muting patterns.

6. The apparatus of claim 1, wherein the uplink resource muting pattern does not overlap with any demodulation reference signal (DMRS) symbols or resource elements (REs), any phase tracking reference signal (PTRS) symbols or REs, or any hybrid automatic repeat request acknowledgment (HARQ-ACK) symbols or REs.

7. The apparatus of claim 1, wherein the at least one processor, to cause the UE to transmit the uplink data or the UCI, is configured to cause the UE to:
skip uplink muting associated with the uplink resource muting pattern in accordance with a quantity of punctured resource elements (REs) satisfying a punctured RE threshold, wherein the punctured RE threshold is a UCI-type-based threshold or a per-symbol threshold.

8. The apparatus of claim 1, wherein the at least one processor, to cause the UE to transmit the uplink data or the UCI, is configured to cause the UE to:
skip uplink muting associated with the uplink resource muting pattern on one or more initial symbols of a PUSCH communication that carries the uplink data or the UCI, or skip the uplink muting on one or more symbols in accordance with a priority associated with the UCI.

9. An apparatus for wireless communication at a network node, comprising:
one or more memories storing processor-executable code; and
one or more processors coupled with the one or more memories, at least one processor of the one or more processors configured to cause the network node to:
transmit an indication of an uplink resource muting pattern, wherein the uplink resource muting pattern overlaps with one or more physical uplink shared channel (PUSCH) symbols in a sub-band full duplex (SBFD) slot; and
receive, in accordance with the uplink resource muting pattern, uplink data or uplink control information (UCI) in one or more available resources associated with the one or more PUSCH symbols.

10. The apparatus of claim 9, wherein the uplink data is punctured and the UCI is rate-matched in accordance with the uplink resource muting pattern.

11. The apparatus of claim 10, wherein hybrid automatic repeat request acknowledgment (HARQ-ACK) information of the UCI, channel state information (CSI) part 1 information of the UCI, and CSI part 2 information of the UCI are rate-matched.

12. The apparatus of claim 11, wherein a set of resource elements (REs) available for transmission of the uplink data does not include a set of REs available for uplink resource muting, and wherein a quantity of REs available for transmission of the UCI is associated with a quantity of the REs available for uplink resource muting.

13. The apparatus of claim 10, wherein hybrid automatic repeat request acknowledgment (HARQ-ACK) information of the UCI and channel state information (CSI) part 1 information of the UCI are rate-matched, and wherein CSI part 2 information of the UCI is punctured.

14. The apparatus of claim 13, wherein a first set of resource elements (REs) available for transmission of the HARQ-ACK information and the CSI part 1 information does not include a set of REs available for uplink resource muting in a set of REs available for transmission of the uplink data, wherein a second set of REs available for transmission of the CSI part 2 information includes the set of REs available for uplink resource muting in the set of REs available for transmission of the uplink data, and wherein a quantity of the REs available for transmission of the HARQ-ACK information and the CSI part 1 information is associated with a quantity of the REs available for uplink resource muting.

15. The apparatus of claim 10, wherein hybrid automatic repeat request acknowledgment (HARQ-ACK) information of the UCI is rate-matched, and wherein channel state information (CSI) part 1 information of the UCI and CSI part 2 information of the UCI are punctured.

16. The apparatus of claim 15, the CSI part 1 information is punctured in accordance with a quantity of punctured available resource elements (REs) satisfying a punctured available RE threshold.

17. The apparatus of claim 15, wherein a first set of resource elements (REs) available for transmission of the HARQ-ACK information does not include a set of REs available for uplink resource muting in a set of REs available for transmission of the uplink data, and wherein a second set of REs available for transmission of the CSI part 1 information and the CSI part 2 information includes the set of REs available for uplink resource muting in the set of REs available for transmission of the uplink data.

18. A method of wireless communication performed at a user equipment (UE), comprising:
receiving an indication of an uplink resource muting pattern, wherein the uplink resource muting pattern overlaps with one or more physical uplink shared channel (PUSCH) symbols in a sub-band full duplex (SBFD) slot; and
transmitting, in accordance with the uplink resource muting pattern, uplink data or uplink control information (UCI) in one or more available resources associated with the one or more PUSCH symbols.

19. The method of claim 18, wherein transmitting the uplink data or the UCI includes:
puncturing the uplink data and rate-matching the UCI in accordance with the uplink resource muting pattern.

20. The method of claim 19, wherein rate-matching the UCI includes rate-matching hybrid automatic repeat request acknowledgment (HARQ-ACK) information, channel state information (CSI) part 1 information, and CSI part 2 information.
